(19) United States
(12) Patent Application Publication
(10) Pub. No.: US 2026/0147860 A1
(43) Pub. Date: May 28, 2026

(54) System and Method for Source Provenance, Derivation Traceability, and Integrity Governance of Information Systems

(71) Applicant: Michel Donald Moore, flemington, NJ (US)

(72) Inventor: Michel Donald Moore, flemington, NJ (US)

(21) Appl. No.: 19/448,102

(22) Filed: Jan. 13, 2026

(51) Int. Cl. G06F 21/10

(52) U.S. Cl. CPC G06F 21/1064

(57) ABSTRACT

A system for safeguarding generated outputs of an intelligent system through non-enforcing provenance evaluation and informational boundary signaling. The system receives generated content and associated contextual metadata, and evaluates longitudinal provenance characteristics across transformations, reuse events, and interpretive contexts. SourceGuard produces traceable records and informational signals indicating provenance integrity, interpretive risk, and boundary conditions associated with the generated output, without restricting generation, modifying outputs, or controlling downstream use. The system operates independently of content generation and execution pathways, enabling audit-ready transparency and interpretive awareness while preserving autonomy of originating systems and human operators.

### FIELD OF THE INVENTION

The present invention relates generally to information systems, artificial intelligence, and digital content governance and, more particularly, to systems and methods for establishing, preserving, and evaluating source provenance, derivation lineage, and integrity of information artifacts across their lifecycle.

The invention pertains to frameworks for tracking origin, transformation, and contextual inheritance of information outputs, including mechanisms for detecting source ambiguity, unauthorized derivation, or provenance degradation, while enabling audit-ready records and human-governed oversight without imposing control over the generation or use of the information itself.

### BACKGROUND OF THE INVENTION

Modern information systems increasingly generate, transform, remix, or synthesize content originating from diverse and often opaque sources. In artificial intelligence systems, data pipelines, and content generation environments, outputs may be influenced by multiple upstream inputs, models, tools, or contextual parameters that are not readily observable after generation.

Existing approaches to provenance tracking are commonly fragmented, relying on ad hoc metadata, platform-specific logging, or informal attribution mechanisms. These approaches often fail to preserve structured lineage describing how an information artifact was derived, what sources influenced it, or how transformations accumulated over time.

As a result, information artifacts may lose traceable connection to their origin, leading to uncertainty regarding authorship, integrity, licensing, accountability, or trustworthiness. In dynamic systems, repeated transformations may further obscure provenance, making it difficult to distinguish between original material, derivative content, and synthesized outputs.

Additionally, many provenance mechanisms conflate tracking with enforcement, embedding restrictions, access controls, or behavioral constraints directly into generation or distribution systems. This conflation complicates governance by transforming provenance indicators into control mechanisms rather than observational records.

Accordingly, there exists a need for a system-level framework that treats source provenance as an observable, persistent, and auditable property; preserves derivation lineage across transformations; enables integrity assessment over time; and supports governance and review without imposing control, restriction, or enforcement on information systems.

### SUMMARY OF THE INVENTION

SourceGuard is a system-level framework for defining, preserving, and evaluating source provenance, derivation lineage, and integrity of information artifacts over time.

SourceGuard treats provenance as a dynamic property that may evolve as information is transformed, combined, or redeployed rather than as a static attribution label. The system provides a repeatable provenance evaluation loop that converts observable source indicators, transformation context, and derivation metadata into a structured provenance state.

SourceGuard produces provenance outputs designed to remain comparable across generations, versions, and deployment contexts, enabling longitudinal traceability and integrity awareness. The system further generates structured records capturing origin references, transformation events, derivation relationships, temporal sequencing, and human participation, thereby enabling auditability and traceable governance.

The system supports operator participation through defined checkpoints for source declaration, contextual framing, and review while maintaining a strict separation between provenance evaluation and content control. SourceGuard does not require access to proprietary model internals, training data, or generation logic and does not depend on any specific artificial intelligence architecture, content platform, or infrastructure.

Through these features, SourceGuard provides a unified framework for source provenance tracking, derivation traceability, and audit-ready integrity governance across the lifecycle of information systems.

### BRIEF DESCRIPTION OF THE DRAWINGS

FIG. 1 illustrates a high-level overview of the SourceGuard system and its interaction with an information system or content generator, including observable source intake, derivation mapping, provenance state generation, temporal lineage comparison, structured record generation, operator checkpoints, and optional external integrity anchoring, without imposing control over content generation or use.

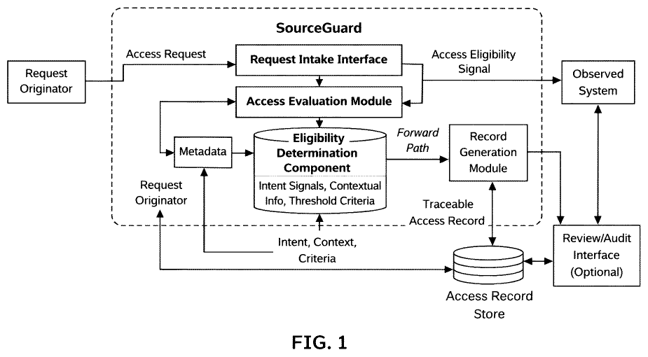

### DETAILED DESCRIPTION OF THE INVENTION

### 1. System Overview

In operation, the SourceGuard system interfaces with an information system, artificial intelligence model, content generator, or data pipeline by receiving observable outputs, declared sources, contextual signals, and transformation descriptors associated with content generation or modification.

The information system under observation may comprise any software system, model, agent, workflow, or composite environment and need not expose internal parameters, training data, prompts, or source code to SourceGuard.

SourceGuard operates as a closed provenance evaluation and record-generation framework that functions alongside the observed system. No enforcement, restriction, or control path is provided from SourceGuard back into the information system.

### 2. Provenance Evaluation Loop

SourceGuard comprises a repeatable provenance evaluation loop that may be executed per output, per transformation event, episodically, or continuously. The provenance evaluation loop includes:
1. Source Intake, in which declared, inferred, or referenced sources are received;
2. Derivation Mapping, in which relationships between sources, transformations, and outputs are identified;
3. Provenance State Generation, producing a structured representation of origin, lineage, and integrity indicators;
4. Temporal Lineage Comparison, in which current provenance states are compared with previously recorded states; and
5. Record Generation, capturing source context, derivation relationships, provenance outputs, and participation metadata.

This loop structure remains consistent across evaluation sessions to enable comparability and longitudinal provenance analysis.

### 3. Source and Derivation Assessment

SourceGuard distinguishes between multiple categories of provenance evidence assessed in parallel, including:
Source attribution evaluation, which considers declared or observable origin references;
Derivation relationship evaluation, which considers transformations, recombination, synthesis, or inheritance across outputs; and
Integrity indicators, which consider consistency, continuity, and contradiction pressure within provenance records.

This separation enables provenance assessment beyond surface-level attribution and supports detection of provenance degradation or ambiguity over time.

### 4. Operator Participation and Checkpoints

SourceGuard incorporates defined operator participation points that allow human declaration of sources, contextual framing of transformations, review of provenance states, or confirmation of lineage interpretations.

Operator participation informs provenance evaluation and interpretation but does not modify, constrain, or control content generation or system operation. Participation pathways may be visually or logically indicated without authority or enforcement.

### 5. Provenance State Output

For each evaluation cycle, SourceGuard produces a provenance state output representing observed origin, derivation, and integrity characteristics at a given point in time. Provenance states are structured to be portable, reviewable, and comparable across outputs, systems, and deployment contexts.

### 6. Temporal Lineage Comparison and Integrity Awareness

SourceGuard compares provenance states across time to identify changes, breaks, or degradation in lineage continuity. Detected changes may be classified according to characteristics such as loss of source clarity, accumulation of derivation distance, or emergence of ambiguity.

Lineage comparison operates on recorded provenance states and does not require direct interaction with the generating system.

### 7. Record Generation and Storage

For each evaluation cycle, SourceGuard generates a structured record preserving:
source references and declarations;
derivation relationships and transformation context;
provenance state outputs;
temporal lineage comparison results; and
operator participation metadata.

Records are stored in a provenance record store designed to preserve traceability and comparability across time, systems, and deployments.

### 8. Optional Verification and Integrity Anchoring

In some embodiments, provenance records may be anchored to an external verification or integrity substrate, such as a distributed ledger or immutable data store, to support independent verification or timestamping.

Such anchoring is optional and does not alter core SourceGuard operation or impose infrastructure dependencies.

### 9. System Boundary and Non-Control Constraint

SourceGuard explicitly separates provenance evaluation from enforcement or restriction. The system does not prescribe actions, mandate attribution usage, restrict content dissemination, or modify system behavior based on provenance outcomes.

Any action taken in response to sourceguard outputs occurs externally and is not part of the SourceGuard system itself.

### Terminology Clarification

As used herein, the term “safeguarding” refers exclusively to informational signaling, provenance record generation, and boundary indication derived from observed source and derivation characteristics. The term does not include enforcement, restriction, behavioral control, authorization, permissioning, or modification of generated outputs or downstream use.

### 10. Non-Limiting Embodiments

SourceGuard may be embodied in various non-limiting forms, including:
provenance evaluation engines for generated content;
derivation tracking layers for Al-assisted workflows;
audit and certification pipelines producing provenance summaries;
governance or compliance review frameworks; and
optional verification layers enabling independent lineage validation.

All embodiments are illustrative and do not alter or supersede the core definition of the SourceGuard system.

1. A system for safeguarding generated outputs of an intelligent system, comprising:
a processing component configured to receive a generated output and associated contextual information;
a provenance association module configured to associate the generated output with metadata describing origin, intent, scope, and interpretive limitations;
a boundary evaluation module configured to generate descriptive boundary status indicators by assessing whether interpretation or reuse of the generated output exceeds the associated scope or limitations, without determining correctness, compliance, authorization, permission, or required action; and
a safeguard record generator configured to produce a structured safeguard record representing provenance characteristics, boundary conditions, and detected interpretive risk, wherein the system operates informationally and independently of content generation, and without modifying, restricting, or controlling the generation or use of the output.

2. A method for safeguarding generated outputs of an intelligent system, comprising:
receiving a generated output and associated contextual information;
associating the generated output with provenance metadata describing origin, intent, scope, and interpretive limitations;
generating descriptive boundary status indicators by evaluating whether interpretation or reuse of the generated output exceeds the associated scope or limitations, without determining correctness, compliance, authorization, permission, or required action; and
generating a structured safeguard record representing provenance characteristics, interpretive boundary status, and detected interpretive risk,
wherein the method provides informational safeguarding without enforcing behavior, authority, or control.

3. The system of claim 1, wherein the provenance metadata includes at least one of generation conditions, originating system identity, transformation context, or interpretive exclusions.

4. The system of claim 1, wherein the boundary evaluation module generates a boundary signal indicating potential misuse, scope drift, or authority drift without preventing, constraining, or altering output use.

5. The system of claim 1, wherein the safeguard record is stored in a record repository enabling traceable audit, comparison, and review across time.

6. The system of claim 1, wherein the safeguarding system operates independently of internal architecture, training data, prompts, parameters, or execution logic of the intelligent system.

7. The system of claim 1, wherein the safeguard record does not include commands, recommendations, approvals, denials, or decision directives.

8. The method of claim 2, further comprising associating temporal metadata with the safeguard record to enable longitudinal assessment of interpretive drift across reuse or transformation events.

9. The method of claim 2, wherein the safeguard record remains associated with the generated output across multiple downstream environments, systems, or interpretive contexts.

10. The system of claim 1, wherein the safeguarding system is implemented as at least one of an annotation layer, audit framework, provenance evaluation service, or governance review module.
